(19) United States
(12) Patent Application Publication
(10) Pub. No.: US 2013/0172139 A1
(43) Pub. Date: Jul. 4, 2013

(54) CONTINUOUSLY VARIABLE TRANSMISSION

(71) Applicants: Robert H. Todd, Provo, UT (US); Dax Wells, Moses Lake, WA (US); Benjamin Groen, Troy, MI (US); John Wyall, Orem, UT (US); Austin Randall, Orem, UT (US); Michael Sanders, Provo, UT (US)

(72) Inventors: Robert H. Todd, Provo, UT (US); Dax Wells, Moses Lake, WA (US); Benjamin Groen, Troy, MI (US); John Wyall, Orem, UT (US); Austin Randall, Orem, UT (US); Michael Sanders, Provo, UT (US)

(21) Appl. No.: 13/488,418

(22) Filed: Jun. 4, 2012

Related U.S. Application Data
(60) Provisional application No. 61/520,033, filed on Jun. 3, 2011.

(51) Int. Cl. F16H 3/72

(52) U.S. Cl. CPC F16H 3/72
USPC 475/1

(57) ABSTRACT

By using a mechanical planetary differential as a multiple input, single output device, the speed of the single output can be controlled by the speed of one of the inputs while the other input may run at a constant speed.

### CROSS-REFERENCE TO RELATED APPLICATION

This application claims the benefit of United States Provisional application by Robert H. Todd, Dax Wells, Benjamin Groen, John Wyall, Austin Randall, and Michael Sanders, filed Jun. 3, 2011.

### BACKGROUND

The following relates to the incorporation of a mechanical differential in automotive applications as well other applications.

Environmental impacts from increasing global motor vehicle activity have caused government entities to regulate emissions from vehicles. For example, the California Air Resources Board has instituted a Zero Emissions Vehicle (AEV) mandate which requires automakers in California to sell a certain percentage of their vehicles with no harmful emissions. The political interest, further fueled by higher fuel costs, consumer and environmental interest, has sparked automakers into an electric revolution with a very uncertain window for profit.

Turning towards a form of electric or hybrid powertrain, car manufacturers have been successful in obtaining mechanical energy from the combination of separate power sources, one source from the rotation of an electric motor and the other source from the rotation of an internal combustion engine (ICE). Additionally, in an effort to create a beltless transmission and thus reduce torque and wear limitations associated therein, some powertrain designs have incorporated the use of a planetary gear set (PGS). Traditionally used for automatic transmissions, the PGS has been incorporated into such vehicles as the Toyota Prius and Chevrolet Volt. Comprising a multiple input, multiple output device to combine energy, the PGS has departed from its traditional use and been made to function as an Infinitely Variable Transmission (IVT) which can have many ratios, thus enabling input sources to run at different speeds while eliminating the friction loss due to traditional use of belts and pulleys.

### SUMMARY

Although the PGS has been successfully used, it is not ideal. Thus, the use of a mechanical planetary differential (PD) is described herein as an alternative to the PGS. Looking at factors such as speed control, AC/DC comparisons, cost, efficiency and design space, a PD optimally allows the development of a positively engaged, infinitely variable, mechanical transmission by using it as a multiple input, single output device. First, control of speed is simplified by utilizing one of the inputs for speed control. A minimal input control motor may serve as a speed controller, allowing another input, the main traction motor device, to run at a constant speed that is most efficient for the traction motor. Such an approach eliminates the costly need to use high-current and high-voltage controllers that are currently being used in electric and hybrid vehicles to control speed of the traction motor. Secondly, the use of less costly and simpler electronic controllers allows the use of DC motors versus AC motors, which further reduces the cost vehicles. Third, design space for gear ratios is enhanced because the constraint of a ring gear in a typical PGS is eliminated. Other advantages may be readily discerned. With a more efficient and less costly system, more environmentally friendly vehicles that are comparable in price to traditional vehicles can be realized and thus reduced emissions, and more efficient use of energy, can materialize.

A mechanical planetary differential (PD) allows multiple inputs from separate power sources to be combined mechanically to produce a single output. Although other differentials can be used similarly, the PD allows greater design space for gear ratio optimization to allow the power inputs of the differential to function at more optimum levels. The PD may also realize significant advantages in efficiency over other types of differentials.

Also, using the differential as a multiple-input/single-output device eliminates the need to “shift gears as well as the need for a clutch, common requirements in a conventional or standard transmission. The resulting differential transmission can have its input to output ratio changed continuously, simply by varying the speed of the second input to the mechanical differential.

### BRIEF DESCRIPTION OF THE DRAWINGS

FIG. 1 is a perspective view of a mechanical differential.

FIG. 2 is a perspective view of a mechanical differential.

FIG. 3 is a cut-out view of a planetary gear set differential.

FIG. 4 is a perspective view of a mechanical planetary differential.

FIG. 5 is an exploded perspective view of a mechanical planetary differential.

FIG. 6 is an exploded perspective view of a mechanical planetary differential.

FIG. 7 is a perspective view of a mechanical planetary differential without a carrier plate and an input shaft.

FIG. 8 is a perspective view of a mechanical planetary differential.

FIG. 8b is a perspective view of a carrier.

FIG. 9 is a frontal view of the mechanical planetary differential.

FIG. 10 is a diagram showing a mechanical planetary differential being used in conjunction with a worm reduction gear.

FIG. 11 is a diagram showing a mechanical planetary differential being used in conjunction with both a reduction gear represented by a small and large gear.

FIG. 12 is a cross-sectional side view of the mechanical planetary differential being used in conjunction with a worm reduction gear.

### DETAILED DESCRIPTION

Automotive Differential 100
Automotive Differential 200
Planetary Gear Set Differential 300
Sun Gear 8
Ring Gear 10
Planet Carrier 12
Mechanical Planetary Differential 400
Sun Gears 102, 103
Planet Gears 104-109
Carrier plates 112, 113
carrier housing 114
carrier 116
output gear 118
input shaft 120
control shaft 122
planet shafts 124-129
Sun Gears 202, 203
Carrier housing 214
Carrier 216
input shaft 220
control shaft 222
Auxiliary motor 224
Worm gear 226

### Sun Gear 8

Ring Gear 10
Planet Carrier 12
Planet Gears 4

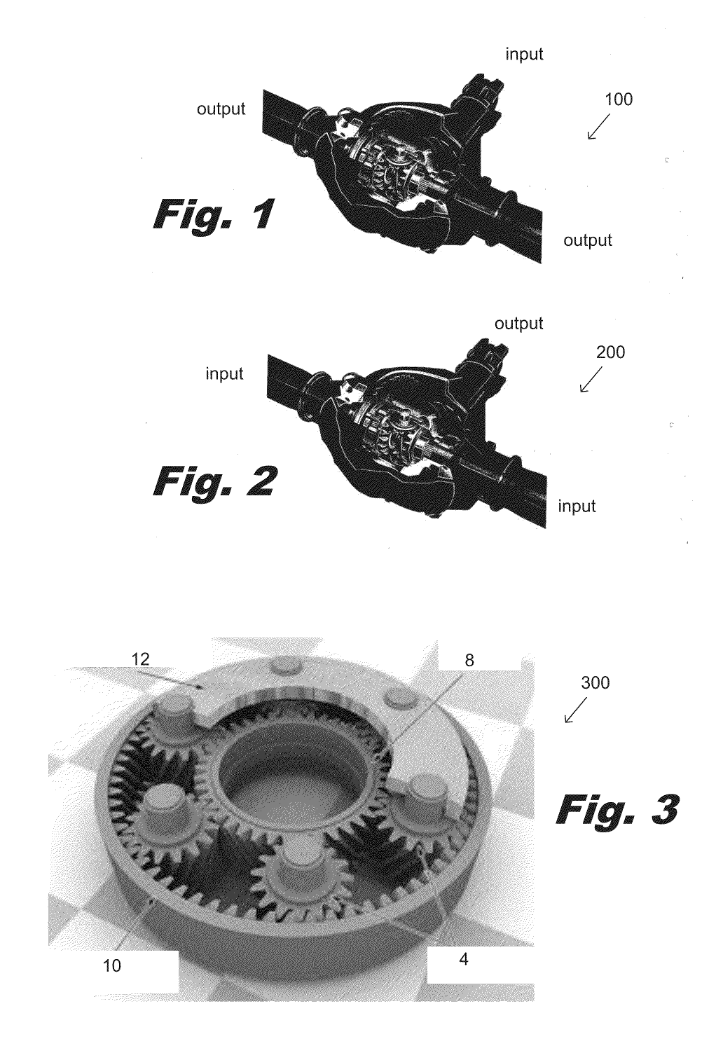

A typical automotive differential (AD) 100 is illustrated in FIG. 1. The AD 100 is primarily used in vehicles as a single-input, multiple-output device to impart different rotational speeds on a set of drive wheels. This allows, for example, drive wheels to turn at different rates when rounding a street corner and thus avoid skid marks from an otherwise dragging tire.

Because the AD 100 is composed of gears in which the input(s) and output(s) remain mechanically connected, the AD 100 may have other use besides the rotation of the drive wheels. Instead, the AD 100 may be used as a multiple-input, single-output device, as illustrated by AD 200 in FIG. 2. Moreover, the AD 200 in FIG. 2 may be used as a transmission that facilitates the multiple inputs. One input may operate as a traction, or a main torque provider for the transmission and hence the vehicle, while the other input may function as a speed governor, or controller for the transmission. The control motor of the speed controller, through appropriate mechanical gearing, may require minimal input torque, and consequently minimal current, to vary the speed of the control motor. This approach eliminates the need to use sophisticated high-current/high-voltage electronic controllers in electric and hybrid vehicles, thereby reducing cost.

This approach also eliminates the need to use a planetary gear set (PGS), a type of differential that is commonly controlled by the sophisticated controller in electric and hybrid vehicles. As shown in FIG. 3, a PGS 300 includes a sun gear 8, a ring gear 10, a planet carrier 12, and a set of planet gears 4. The sun gear 8 meshes with the set of planet gears 4. The set of planet gears 4 are fixed via shafts and bearings to the planet carrier 12 that serves as one of the input/outputs of the PGS 300. The planet gears 4 are also in mesh with the ring gear 10. Both the sun gear 8 and the planet gears 4 reside within the diameter of the ring gear 10.

Inputs/outputs may be provided by the sun gear 8, the planet carrier 12, and the ring gear 10. One example of the functionality of the PGS 300 is to have the sun gear 8 serve as one input that is driven by an electric motor. A second input is provided torque from a gasoline engine and may be transferred through the planet carrier 12. The output angular velocity of the ring gear 10 would then be a function of the difference of the two input angular velocities from the sun gear 8 and the planet carrier 12. Thus, it can readily be seen how a planetary gear set integrates two power sources to control the speed of the output. It is to be understood, however, that any two input/outputs can be used to control the angular velocity of the third input/output.

Although power is being combined from two inputs or power sources in the PGS 300, the output angular velocity, and ultimately the speed of the traction motor is controlled with a sophisticated, and costly, electronic controller. Note also that ring gear 10 in the PGS 300 constrains the optimization of gear ratios. The two gear mesh ratios are selected and the remaining ratio is set as a function of the first. For example, the number of teeth needed on the ring gear 10 and planetary gears 4 for a certain ratio may have been chosen and as a result, the sun gear 8 must be a certain diameter to make positive engagement of the planet gears possible. In this way, the ring gear 10 in the PGS 300 limits the optimization of ratios for the device.

The PGS 300 is currently used as a transmission that can change steplessly through an infinite number of effective gear ratios between maximum and minimum values, and which allows the input to be driven at a constant angular velocity over a range of output velocities. This type of transmission is known as a continuously variable transmission (CVT). The PGS 300 includes a range of ratios of output speed to input speed that include a zero ratio that may be continuously approached, resulting in a “neutral”, or non-driving “low” gear limit, in which the output speed is zero. Because of this capability, the PGS 300 belongs to a specific type of Continuously Variable Transmissions (CVTs) known as Infinitely Variable Transmissions (IVTs).

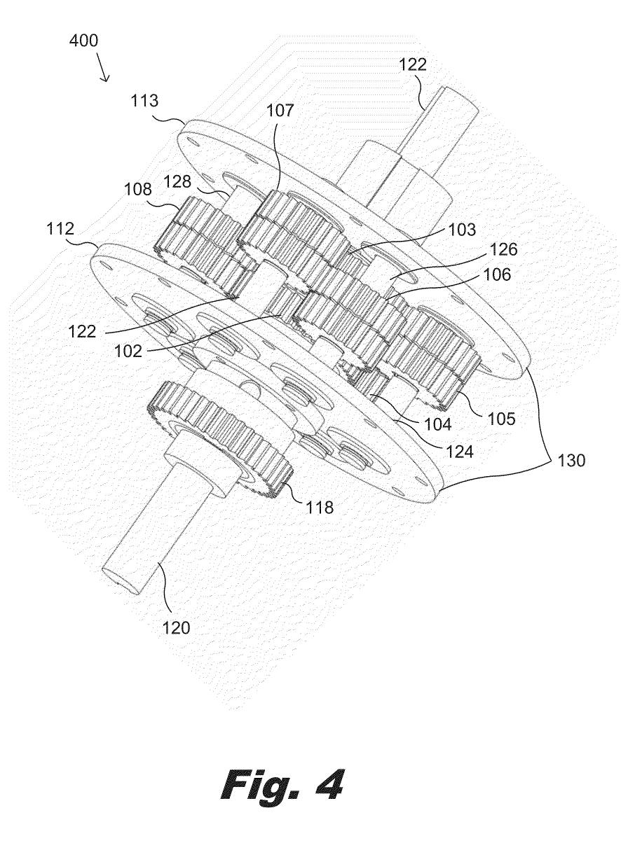

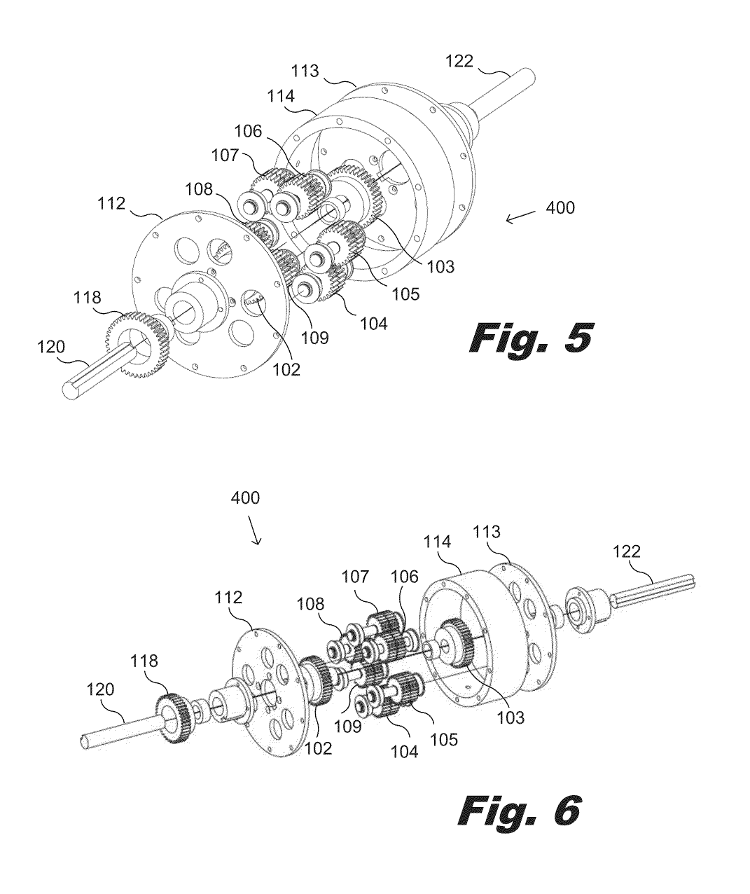

Turning to FIGS. 4-6, perspective views of a planetary differential (PD) 400 are illustrated. Note that in FIGS. 5 and 6, PD 400 is in exploded perspective form. The PD 400 may be used as a CVT and similar to the PGS 300, may also be used as an IVT.

The PD 400 includes sun gears 102 and 103; a first set of planet gears 104, 106, and 108; a second set of planet gears 105, 107, and 109; output gear 118; input shaft 120; and control shaft 122. The PD 400 further includes a carrier 130 comprising carrier plates 112 and 113; carrier housing 114; a first set of pins 124, 126, and 128; and a second set of pins 125, 127, and 129.

Regarding the input shaft 120 connections, the input shaft 120 is rigidly connected to sun gear 102 at a location along the length of the input shaft 120. The sun gear 102 meshes with a first set of planet gears 104, 106, and 108. The input shaft 120 is also connected to the center of the carrier plate 112 at a location along the length of the input shaft 120, however, the shaft-to-plate connection is not rigid. Instead, the input shaft 120 allows carrier plate 112 to freely rotate around the longitudinal axis of the input shaft relative to the input shaft 120.

Regarding the control shaft connections, the control shaft 122 is rigidly connected to sun gear 103 at a location along the length of the control shaft 122. The sun gear 103 meshes with a second set of planet gears 105, 107, and 109. The control shaft 122 is also connected to the center of carrier plate 113 at a location along the length of the control shaft 122, however, the shaft-to-plate connection is not rigid. Instead, the control shaft 122 may allow the carrier plate 113 to freely rotate around the longitudinal axis of the control shaft 122.

Note that the axes of the input shaft 120 and the control shaft 122 are coaxial, however, they may not be connected. Embodiments may include that the carrier 130 be rigidly attached to a single shaft that runs the length of input shaft 120 and control shaft 122 and which replaces these two shafts. Embodiments further include an input shaft and a control shaft that are hollowed and through which may run a single shaft. Thus, the ends of the single shaft are disposed within the hollowed ends of input and control shafts. The sun gear 102 may be rigidly attached to the hollowed input shaft which is coaxial with the single shaft and through which runs the single shaft. The other sun gear 103 may also be rigidly attached to its respective control shaft, and coaxial with the single shaft and through which also runs the single shaft. In this manner, the single shaft rotatably connects the sun gears 102 and 103 but does not constrain their individual rotational movements relative to each other or to the single shaft. Additional types of shafts and connections may be used.

Turning to pin-to-carrier connections, each pin of the pins 124-129 has one end connected or joined to carrier plate 112 and one end connected or joined to carrier plate 113 such that each pin is connected or joined in an orthogonal manner to carrier plates 112 and 113. Also, carrier housing 114 is connected or joined to carrier plates 112 and 113. Because the carrier plates 112 and 113 are connected by the pins 124-129 and the carrier housing 114, the rotational movement of the carrier plate 112 will be synonymous or in sync with the rotational movement of the carrier plate 113, pins 124-129, and carrier housing 114. Moreover, the carrier plates 112 and 113, the carrier housing 114, and the pins 124-129 make up the carrier 130 of PD 400.

Regarding the pin-to-planet connections, each planet gear of the planet gears 104-109 may be fixed at a location along the longitudinal length of its respective pin of the pins 124-129. For example, planet gear 104 may be fixed at a location along the length of pin 124. Also, the central axis of each planet gear may be aligned with the longitudinal length of its respective pin. Fixed and aligned, the planet gears 104-109 may also be rotatably supported by their respective pins 124-129, the pins 124-129 extending from a first planar surface on the carrier plate 112 to a second planar surface on the carrier plate 113. Along the central axis of each planet gear—and thus, along the longitudinal length of each planet gear's respective pin—each planet gear may freely rotate relative to its respective pin. Furthermore, when the planet gears 104-109 are enmeshed, they may rotate with respect to each other. In other words, the planet gearing is not rotationally restricted or restrained by the pin-to-planet connection.

Note, however, that the first set of planet gears 104, 106, and 108 is mechanically engaged and driven by sun gear 102. Similarly, the second set of planet gears 105, 107, and 109 is mechanically engaged and driven by sun gear 103. Sun gears 102 and 103 may be configured such that they are able to rotate independent of each other while planet gears 104, 106, and 108 may be configured to mesh with planet gears 105, 107, and 109.

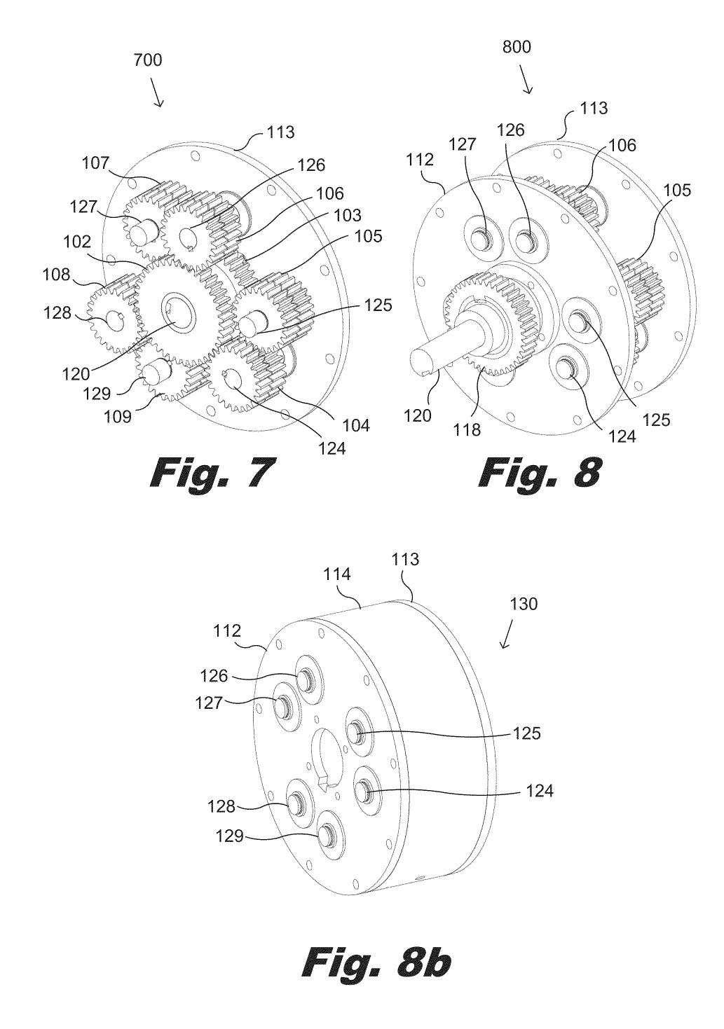

The carrier-to-planet connection 700 is demonstrated by first showing plateless carrier 700 comprising the gears without the carrier plate 112, as shown in FIG. 7. Second, plated carrier 800 shows the gears connected with the carrier plate 112, as shown in FIG. 8. The carrier 130 itself comprises carrier plates 112 and 113, carrier housing 114, and pins 124-129, as shown in FIG. 8b.

The torque provided by sun gear 102 rotates the first set of planet gears 104, 106, and 108. The torque provided by sun gear 103 rotates the second set of planet gears 105, 107, and 109. If the sun gears 102 and 103 rotate in the same direction but at different angular velocities, they will cause their planet gears to rotate, and the rotational movements of the planet gears will sum together. If the carrier 130 is physically restrained or otherwise not free to rotate around its longitudinal axis, the rotation of planet gears 104-109 will sum together and display rotational movement around their respective axes. A restraint on the carrier 130 reduces the PGS 400 to a single input and single output device. On the other hand, if the carrier 130 is free to rotate, the rotation of planet gears will sum together and manifest itself in rotational movement of the carrier as well as translational, but not rotational, movement of the planet gears. Both the rotational movement of the carrier and the translational movement of the planet gears will be with respect to the central axis of the carrier 130. In other words, the carrier 130 will rotate around its axis while the planet gears 104-109 revolve around the axis of the carrier 130.

The rotational motion of the carrier 130 may be associated with an output gear 118 that is rigidly connected to the carrier 130 and which serves as the output speed of the transmission. The output gear 118 may further be attached or connected with a different shaft that serves as the output of the transmission.

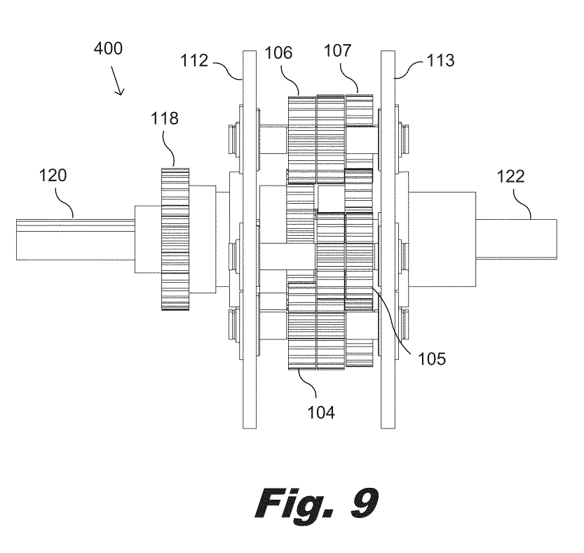

FIG. 9 shows a frontal view of the PD 400 with the meshing of the planet gears. Although the input/output of PD 400 is described herein as having input shaft 120, control shaft 122, and the output of carrier 130, with their respective input/output contributions, embodiments may switch roles. For example, the carrier 130 may serve as an input, while control shaft 122 serves as an output. Also, components or additional components may be included to convey the actual input or output velocities to the rest of the transmission components. As described in the previous example, output gear 118, instead of carrier 130, may mechanically communicate the output velocity of the PD 400.

The behavioral motion for the PD 400 can be explained by describing the angular velocity relationship between the input shaft 120, the control shaft 122, and the output gear 118 in the following equation:

$$rpmC = \frac{rpmA + rpmB}{2}$$

where rpmA is the angular velocity of the input shaft 120, rpmB is the angular velocity of control shaft 122, and rpmC is the angular velocity of the output gear 118. This equation may still be applicable if the inputs and outputs are changed with variables changed accordingly.

Assuming no power loss, the power relationship between the PD 400 can be described by the following equation:

Ta*rpmA+Tb*rpmB+Tc*rpmC=0

where Ta is the torque at input shaft 120, Tb is the torque at control shaft 122 and Tc is the torque at the output gear 118. If shafts 122 and 120 provide torque to the PD 400 at a given angular velocity, the sum of their respective products along with the product of the output gear 118 angular velocity and torque would be equal to zero. This equation may still be applicable if the inputs and outputs are changed and variables changed accordingly.

On the input side, the first input shaft 120 may be driven by a torque provider, such as a traction motor, engine, or other prime mover for the input source. The torque provider operates as a traction or main power source for the transmission. Because the control input varies the speed for the transmission, the torque provider may run at a constant speed that is most efficient for the main power source. Alternatively, the speed may be semi-constant. Embodiments include a torque provider with a range of speeds that may be held constant and semi-constant. Embodiments include a range of speeds that are not necessarily at a constant RPM. Furthermore, embodiments include a torque provider with one or more speeds that are most efficient for the PD 400, the transmission, and any efficiency goals or other goals to be had in the vehicle.

The other or second input includes the control shaft 122 and is driven by an auxiliary motor, or other power source. The control shaft 122 may be connected to sun gear 103 and thereby function as a speed controller, or governor for the output speed of the output gear 118, and ultimately the transmission. In embodiments, the gear ratio or gear state may be understood to be the ratio between the total speed input (as driven by the torque provider and the auxiliary motor) and the speed output.

In particular, the speed controller (control shaft 122 and sun gear 103), through appropriate mechanical gearing, may require a minimal input torque from the auxiliary motor. This is advantageous because torque required by the control motor is minimal compared to torque required for current controllers. Thus, a small amount of torque—and hence, a minimal amount of current—may be used to vary the speed of the control motor.

Because of the small current required, the electronic controller may comprise a simple and inexpensive DC controller controlling a relatively small DC motor rather than the sophisticated and expensive AC controllers used in electric and hybrid vehicles to control the AC traction motor. Embodiments may still include an AC controller, however. Also, embodiments may include both types of controllers.

Also, note that the PD 400 allows greater design space for gear ratio optimization than the design space currently presented in electric and hybrid vehicles. Simply put, out of the four gear types in the PD 400—sun gear 102, first set of planet gears 104, 106, and 108 that mesh with sun gear 102, second set of planet gears 105, 107, and 109, second set of planet gears 105, 107, and 109 that mesh with sun gear 103, and sun gear 103—three of the four gear types may have diameters, that are selected independently from each other. The remaining gear type diameter is then dependent on the other three gear type diameters and corresponding gear ratios. This type of freedom is not available within a PGS 300 and other differentials where the selection of planet gear diameters are constrained by the diameter of the ring gear.

Such freedom in design in the PD 400 offers a means of achieving greater efficiency and optimization than is currently permitted in electric and hybrid vehicles. With a flexible regime of gear diameters and corresponding gear ratios, power inputs that function at more optimum levels may be selected. Moving from a conventional planet gear set, such as the PGS 300, to a planetary differential like the PD 400 allows a broader range of gear ratio optimization and thus holds promise for future hybrid vehicle powertrain applications.

The PD 400 may provide a positive displacement (gears always meshing), continuously variable transmission. With the PD 400, the differential can have its input-to-output ratio changed continuously simply by varying the speed of the second, or control, input to the mechanical differential. Thus, the PD 400 eliminates the need to “shift gears” as is required in a conventional transmission and also eliminates the need for a clutch to be used to facilitate the required shifting in a conventional transmission. Because the PD 400 does not depend on friction, it also provides an alternative to friction-dependent continuously variable transmissions or CVTs as used in snowmobiles or ATVs and metal “push belt” CVTs used in automobiles. Other types of differentials, such as spur or straight gear planetary differentials, allow continuous variation and thus may also be used in the place of or in conjunction with the PD 400.

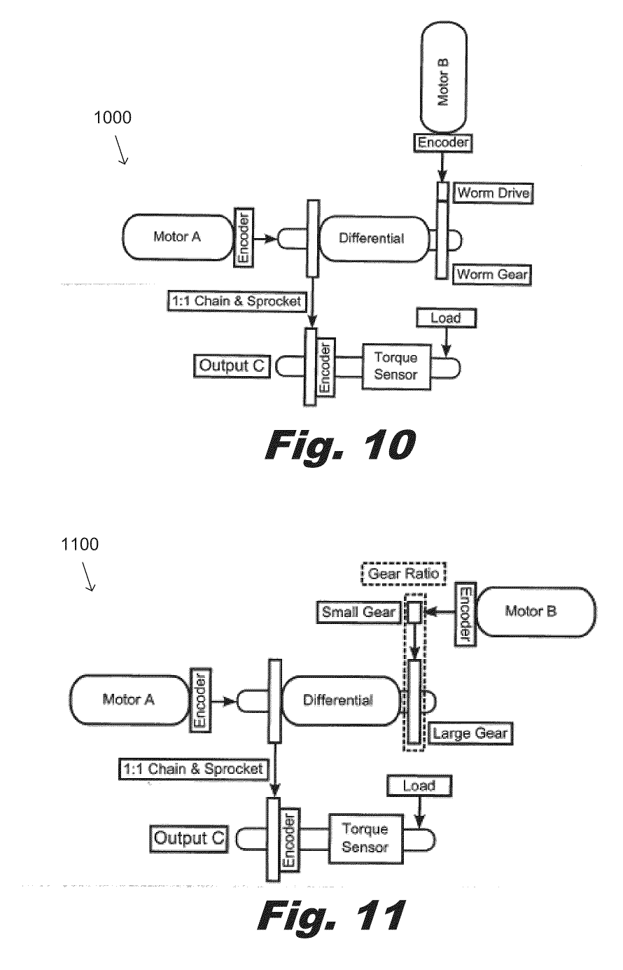

FIG. 10 shows diagram 1000 that incorporates a worm gear with embodiments described herein. A worm drive is connected to an output shaft of motor B to turn a worm gear connected to the control shaft 122 or sun gear 103. Motor B may represent a motor, such as the auxiliary motor. In FIG. 11, diagram 1100 replaces the worm gear with a spur gear. With either a worm gear or a spur gear reducer, mechanical power displacement, known as backdrive, may be overcome. A phenomenon among epicyclic drive trains, of which differentials are a subset, backdrive occurs when one input drives the other input instead of driving the output. Backdrive is dependent on the amount of resistive torque that each input provides to the system. A main principle of backdrive is that torque will flow in the path of least resistance through the differential. Therefore, the solution to preventing backdrive may be realized by increasing resistance between inputs or decreasing resistance to the output.

Because the output torque resistance is the parameter to be satisfied, the solution may reside in increasing resistance between the inputs. Because the path of least resistance between the input shaft 120 and the control shaft 122 resides in the control shaft 122, resistance means may be placed on or at the control shaft 122. Embodiments may include resistance on or at one or both input shafts. The means of resistance may comprise gear reduction means via a spur gear reducer or a worm gear reducer. Other methods of increasing resistance include helical or hypoid gear sets, cycloidal gear reducers, harmonic drives, electromagnetism or hydrodynamic resistance, or through the use of a one-way clutch device, to name a few. In application, one of the means of resistance, or backdrive solutions (BDS), may be applied to the control shaft or input, thus increasing the torque necessary to rotate the control shaft or input opposite the direction that is desired.

In evaluating BDS through gear reduction, it may be helpful to know the relationship between input parameters and gear ratios that may affect differential backdrivability. Gear reduction may also affect the necessary operating range of each input torque and RPM. Thus, the governing equations for a mechanical differential, with straight bevel or spur gears, are as follows:

$$rpmOutput = \frac{rpmA * \frac{NmotorA}{NinputA} + rpmB * \frac{NmotorB}{NinputB}}{2}$$

where rpmA is the RPM of the primary torque provider, NmotorA is the number of teeth attached to the primary torque provider, NinputA is the number of teeth on the gear connected to a first input shaft, rpmB is the RPM of the auxiliary motor, NmotorB is the number of teeth attached to the auxiliary motor, and NinputB is the number of teeth on the gear connected to a second input shaft. The variables may be applicable according as the inputs and outputs are applied.

$$\frac{TOutput}{2} = TmotorA * \frac{NinputA}{NmotorA} = TmotorB * \frac{NinputB}{NmotorB}$$

where Toutput is the torque requirement at the output, TmotorA is the torque of the main torque provider, NmotorA is the number of teeth on the gear attached to the main torque provider, NinputA is the number of teeth on the gear fastened to the input shaft, TmotorB is the torque of the auxiliary motor, NmotorB is the number of teeth on the gear attached to the auxiliary motor, and NinputB is the number of teeth on the gear fastened to the input B shaft. The variables may be applied to the appropriate inputs and outputs. Also, the equations may be altered when inputs are operated in opposite directions or the PD contains gears with helical attributes.

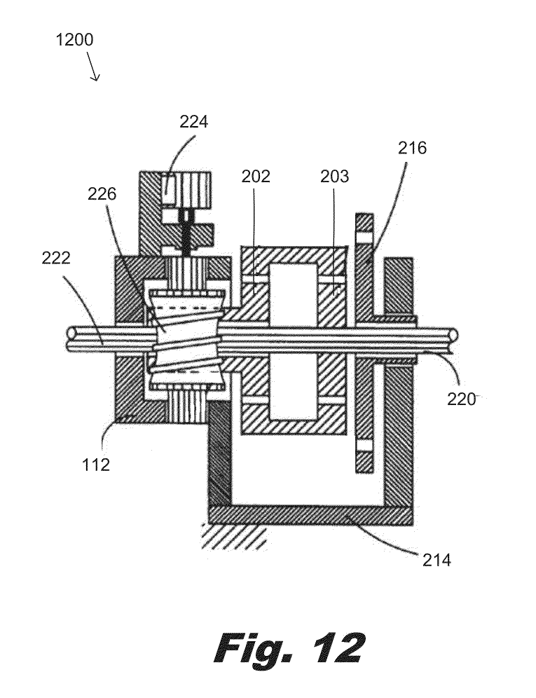

Turning to FIG. 12, FIG. 1200 shows the PD 400 used along with a worm gear 226. FIG. 12 also shows the carrier housing 214, the carrier 216, the input shaft 220, the control shaft 222, and an auxiliary motor 224. Using an auxiliary, or control, motor 224 to turn a worm gear that is connected to the control shaft 222 may help to control backdrive initiated from the input shaft 220. In general, gear reduction limits backdrive by providing sufficient torque to make the path of least resistance be the output instead of the auxiliary motor. This may be advantageous as the carrier 216 is increasingly loaded.

As previously mentioned, embodiments may further include helical or hypoid gears, spur gears, cycloidal gear reducers, harmonic drives, resistance through electromagnetism or hydrodynamic resistance, a one-way clutch, among other resistance means, and in addition to or in lieu of the use of the worm gear.

Helical or hypoid gears have increased friction and therefore are more resistant to backdrive. They are also generally quieter during operation than bevel or spur gears, but less efficient. Although not as effective at preventing backdrive as the worm drive, spur gears are commonly used in automotive transmissions and with appropriate ratio reductions can produce good RPM/torque tradeoffs. Gear reduction can also be done internally through gear ratio choices in a mechanical planetary differential instead of externally.

Note that backdrive may actually be desirable in circumstances because it may help control the output velocity of the gear shaft 118. Thus, the use of a worm gear or other resistance means is advantageous in providing control over the amount of backdrive that may affect the output velocity of the gear shaft 118.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed is:

1. A drive system comprising:
a mechanical planetary differential that includes a first input driven by a torque provider; a second input driven by an auxiliary motor; and an output driven by the combination of the first input and the second input, wherein the second input controls a gear ratio between the first input and second output; and
a gear reduction means connected to the second input that controls a backdrive communicated to the second input.

2. The system in claim 1, wherein the first input comprises a first sun gear, a second sun gear, or a carrier.

3. The system in claim 1, wherein the second input comprises a first sun gear, a second sun gear or a carrier.

4. The system in claim 1, wherein the output comprises a first sun gear, a second sun gear, or a carrier.

5. The system in claim 1, wherein the mechanical planetary differential includes one or more additional mechanical planetary differentials.

6. The system in claim 1, wherein the mechanical planetary differential comprises a first sun gear in mechanical communication with a first set of planet gears; a second sun gear in mechanical communication with a second set of planet gears; and a carrier that is axially engaged with the first sun gear and the second sun gear, wherein the first set of planet gears is enmeshed with the second set of planet gears, and wherein the carrier is in mechanical communication with the first set of planet gears and the second set of planet gears.

7. The system in claim 6, wherein the first sun gear, the second sun gear, or the carrier rotates at constant speed.

8. The system in claim 6, wherein the first sun gear, the second sun gear, or the carrier rotates at a variable speed.

9. The system in claim 6, wherein the first sun gear, the second sun gear, or the carrier is the output of the mechanical planetary differential.

10. The system in claim 1, wherein the output is coupled to one or more drive wheels of a vehicle.

11. The system in claim 1, wherein the gear reduction means comprises a worm gear.

12. The system in claim 12, wherein the worm gear is in communication with the second input.

13. A method for operating a transmission comprising:
rotating a first sun gear at a constant speed with a traction motor;
communicating the rotation of the first sun gear to a first set of planet gears;
rotating a second sun gear at a variable speed with an auxiliary motor;
communicating the rotation of the second sun gear to a second set of planet gears;
enmeshing the first set of planet gears with the second set of planet gears;
preventing backdrive between the first sun gear and the second sun gear; and
driving a carrier that mechanically engages the first set and second set of planet gears.

14. The method of claim 13, wherein the carrier is in mechanical communication with one or more drive wheels of a vehicle.

15. The method of claim 13, wherein the means for preventing backdrive includes a spur gear reduction or worm gear.

16. The method of claim 13, wherein driving a carrier may include one or more additional sun gears with one or more additional sets of planet gears.

17. A drive system comprising:
torque provider,
auxiliary motor,
mechanical planetary differential that includes
first input driven by the torque provider;
second input driven by the auxiliary motor,
output driven by the combination of the first input and the second input such that rotational speed of the second input controls a gear ratio between the first input and second output;
the second output including gear reduction that increases torque required to drive the second input from the first input such that torque from the first input is directed to the output.
